(19) United States
(12) Patent Application Publication
(10) Pub. No.: US 2016/0087253 A1
(43) Pub. Date: Mar. 24, 2016

(54) BATTERY BASKET

(71) Applicant: Gerald J. Lorino, Manahawkin, NJ (US)

(72) Inventor: Gerald J. Lorino, Manahawkin, NJ (US)

(21) Appl. No.: 14/491,677

(22) Filed: Sep. 19, 2014

(51) Int. Cl. H01M 2/10

(52) U.S. Cl. CPC H01M 2/1005

(57) ABSTRACT

An assembly for easily inserting, removing and carrying a motorcycle battery. The assembly comprises a plurality of bands secured together by at least one junction. A grip member can be used for enhanced carrying ease. A pull member, or multiple pull members, can be secured to the assembly for efficiently guiding the battery once the assembly is engaged with the battery, such as in inserting or removing the battery from a battery compartment, and in carrying the battery.

### BACKGROUND

A motorcycle battery must store enough physical energy to start a power-hungry engine at a moment's notice. However, it also must be of a size modest enough to fit in the confined space of a sleek motorcycle body. As a result, a motorcycle battery tends to be a heavy item that must be slipped into and out of a confined area. Installing and removing a motorcycle battery is a process that can be time-consuming, cumbersome and has the potential of damaging the housing containing the battery, and the process can also make its mark on fingers and feet of motorcycle mechanics and enthusiasts.

### BRIEF DESCRIPTION OF DRAWINGS

FIG. 1 illustrates a perspective view of an example battery basket in accord with various embodiments.

FIG. 2 illustrates a perspective view of an example of a battery basket, engaged with an example of a battery, in accord with various embodiments.

FIG. 3 illustrates a perspective view of an example of a battery basket, and an example of a pull member, in accord with various embodiments.

FIG. 4 illustrates a side view of an example of a battery basket, and an example of multiple pull members, in accord with various embodiments.

### DETAILED DESCRIPTION

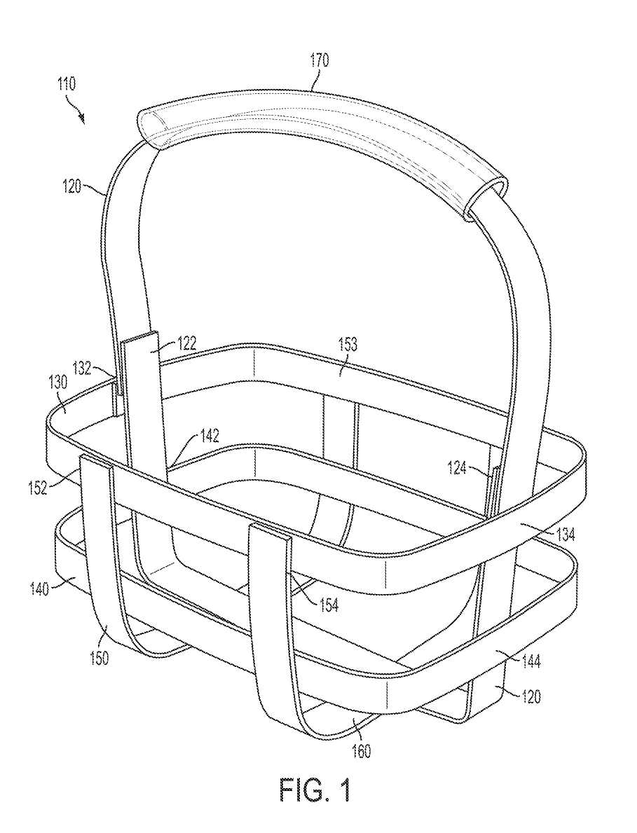

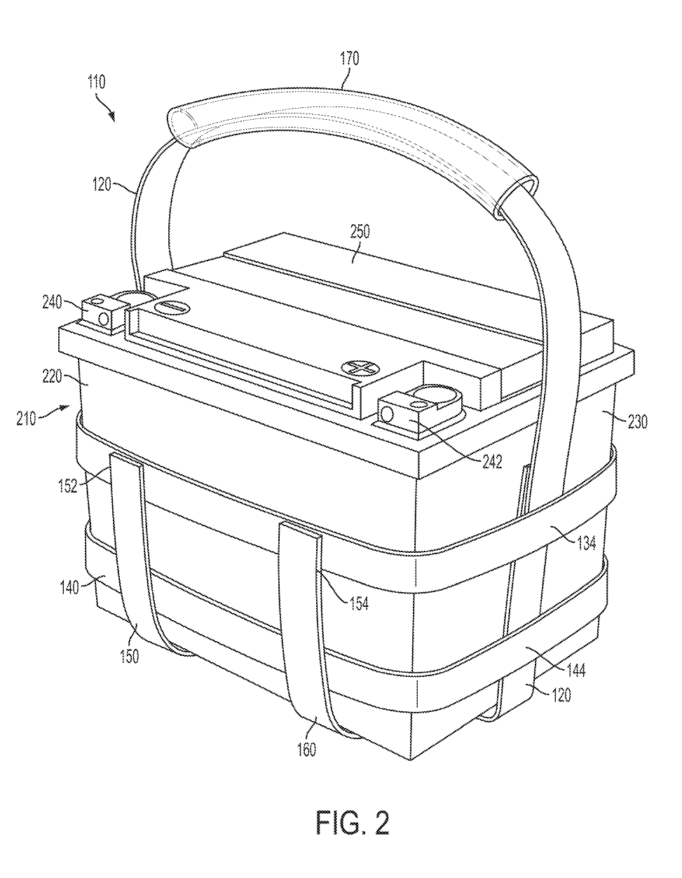

FIG. 1 depicts a battery basket 110. In an embodiment, battery basket 110 can include a vertical band 120. Vertical band 120 can provide support to and otherwise act to constrain movement relative to the bottom and side casings of a battery (an illustration of an example battery 210 in battery basket 110 can be seen in FIG. 2). Disposed in the general configuration of a loop, vertical band 120 can comprise material such as a synthetic polymer, natural material, combination of the two, or any other material suitable for engaging a battery 210. The material comprising vertical band 120 can be a heavy duty fabric or other substance. Vertical band 120 can comprise a single strip of material secured at a junction 122. It can comprise two strips of material secured at a junction 122 and junction 124. The securing can be accomplished by stitching or other structure or process. The material can be substantially flexible (such that it can, among other things, be tucked next to the battery 210 during operation) but must be strong enough, in conjunction with the rest of the structures, to handle the weight of a battery. It will be appreciated that multiple strips of material can be used to form vertical band 120.

Vertical band 120 can have an upper portion on which a grip member 170 can be disposed. Grip member 170 can comprise a structure placed on and/or around vertical band 120 to assist in lifting, carrying, or otherwise manipulating a battery 210.

First horizontal band 130 can be adjacent to vertical band 120, and will be disposed at an angle relative to vertical band 120. In an embodiment, first horizontal band 130 can be substantially 90 degrees relative to vertical band 120. However, the angle can be non-perpendicular so long as it is non-zero or, understood another way, not 180 degrees. First horizontal band 130 can be secured to vertical band 120 by a junction 132 and junction 134, the securing accomplished by stitching or other structure or process. First horizontal band 130 can provide support to and otherwise act to constrain movement relative to the sides of a battery. Disposed in the general configuration of a loop, first horizontal band 130 can comprise material such as a synthetic polymer, natural material, combination of the two, or any other material suitable for engaging a battery 210. The material comprising first horizontal band 130 can be a heavy duty fabric or other substance. The material can be substantially flexible but must be strong enough, in conjunction with the rest of the structures, to handle the weight of a battery. First horizontal band 130 can comprise a single strip of material or multiple strips.

In an embodiment, a second horizontal band 140 can be used. Second horizontal band 140 can be substantially 90 degrees relative to vertical band 120. However, the angle can be non-perpendicular so long as it is non-zero or, understood another way, not 180 degrees. Second horizontal band 140 can be disposed generally parallel to first horizontal band 130. Second horizontal band 140 can be secured to vertical band 120 by a junction 142 and junction 144, the securing accomplishing by stitching or other structure or process. Second horizontal band 140 can provide support to and otherwise act to constrain movement relative to the sides of a battery. Disposed in the general configuration of a loop, second horizontal band 140 can comprise material such as a synthetic polymer, natural material, combination of the two, or any other material suitable for engaging with a battery. The material comprising second horizontal band 140 can be a heavy duty fabric or other substance. The material can be substantially flexible but must be strong enough, in conjunction with the rest of the structures, to handle the weight of a battery. Second horizontal band 140 can comprise a single strip of material secured at a junction 142 or multiple strips secured at multiple junctions 142, 144.

A first support band 150 can be disposed to engage the base of and sides of, a battery 210. First support band 150 can be substantially 90 degrees relative to first horizontal band 130 and/or second horizontal band 140. However, the angle can be non-perpendicular so long as it is non-zero or, understood another way, not 180 degrees. First support band 150 can be secured to first horizontal band 130 by a junction 152 and junction 153, the securing accomplishing by stitching or other structure or process. Added junctions can be used. First support band 150 can provide support to and otherwise act to constrain movement relative to the bottom and sides of a battery. First support band 150 can comprise material such as a synthetic polymer, natural material, combination of the two, or any other material suitable for engaging a battery. The material comprising first support band 150 can be a heavy duty fabric or other substance. The material can be substantially flexible but must be strong enough, in conjunction with the rest of the structures, to handle the weight of a battery. First support band 150 can comprise a single strip of material or multiple strips.

First support band 150 can be disposed generally halfway between two opposite sides of first horizontal band 130 and/or second horizontal band 140. Alternatively, first support band 150 can be disposed closer to a first side of first horizontal hand 130 and/or second horizontal band 140, and a second support band 160 can be disposed closer to the opposite side, as appropriate, of first horizontal band 130 and/or second horizontal band 140. Using a first support band 150 or second support band 160 can strengthen the apparatus and constrain movement for added ease of battery removal, insertion, and carrying.

Second support band 160 can be used with first support band 150. Using a first support band 150 and/or second support band 160 can strengthen the apparatus and constrain movement for added ease of battery removal, insertion, and carrying. Second support band 160 can have location and properties similar to those of first support band, e.g., angle relative to first horizontal band 130 and or second horizontal band 140, material of which it is comprised, how it is secured, and comparable characteristics.

FIG. 2 depicts an example battery 210 used in conjunction with an embodiment of battery basket 110. The battery casing can include a side casing 220 and side casing 230 (and other side casings, not shown). There can be a top casing 250 (and bottom casing, not shown). There can be a terminal 240 and terminal 242. It will be appreciated that battery 210 can be inserted into battery basket 110. Battery basket 110 can supportably engage relevant portions of side casing 220 and side casing 230 (and other side casings not shown). Battery basket 110 can leave open, and not interfere with, top casing 250 including terminals 240, 242.

Battery 210 can be inserted into battery basket 110, and then carried easily to the motorcycle. At this point, battery basket 110 containing battery 210 can be slipped into the motorcycle body battery compartment (not shown) in which the battery is housed during normal motorcycle operation. In addition, battery basket 110 can be inserted first into the battery compartment, and then battery 210 can be inserted therein.

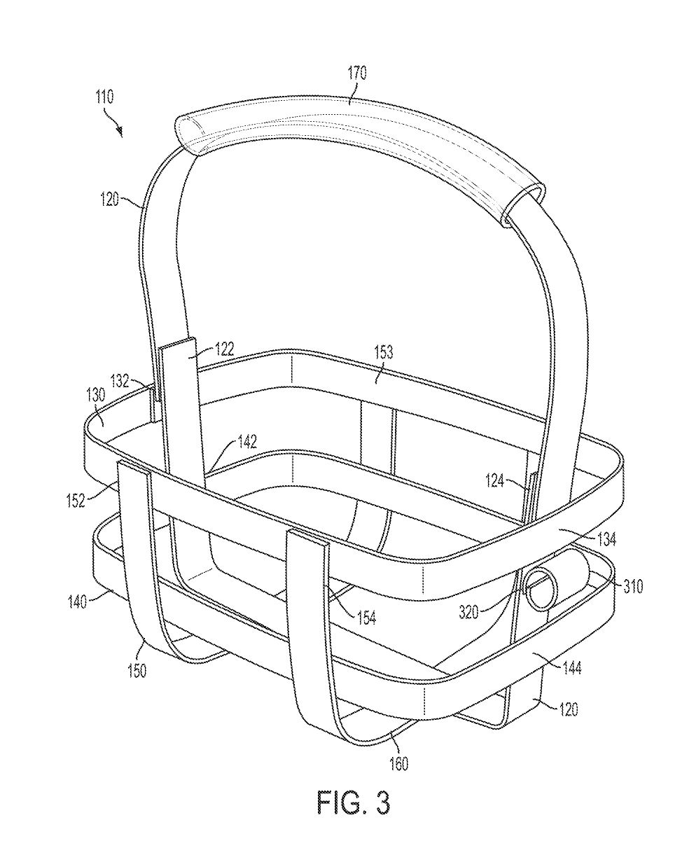

FIG. 3 depicts an embodiment of a battery basket 110 that includes a pull member 310. Pull member 310 can have a generally loop-shaped configuration. Pull member 310 can be formed from one strip of material or multiple strips. Also, pull member 310 can be secured to battery basket 110 at a suitable location such as vertical band 120, such that battery basket 110 can be pulled or guided. The securing can be by stitching or other structure or process.

Pull member 310 in embodiments can be of an added shape and/or structure. For example, it can be a hook of a reasonably rigid material. It can be a mechanism that can be manually pulled, pinched or engaged for the purpose of added navigation and/or support of battery basket 110.

A motorcycle battery is typically housed in a compartment that is a top-replace or side-replace. With a top-replace, in general the seat can be removed for access to the battery compartment. Then the battery can be lifted upwards and away from the motorcycle. With a side-replace, the compartment can be accessible from the side of the motorcycle. The battery can then be slid laterally out of the motorcycle. Pull member 310 can be used for both top-replace and side-replace compartments. A use for pull member 310 is in lateral removal of a battery from the battery compartment, where the battery compartment is accessible from the side of the motorcycle frame or body. Another use for pull member 310 is assisting with top removal of a battery. Accordingly, pull member 310 can be used to guide and/or support battery basket 110 during insertion or removal of battery basket 110 from the battery compartment of a motorcycle. Pull member 310 can also be used in handling the battery basket 110, into which a battery 210 has been inserted, outside a motorcycle. Pull member 310 can be located on vertical band 120, first horizontal band 130, or indeed on any of the battery basket's structures where it is suitable for pulling and/or guiding. Pull member 310 can engage battery basket 110 by a junction 320 by stitching or other structure or process.

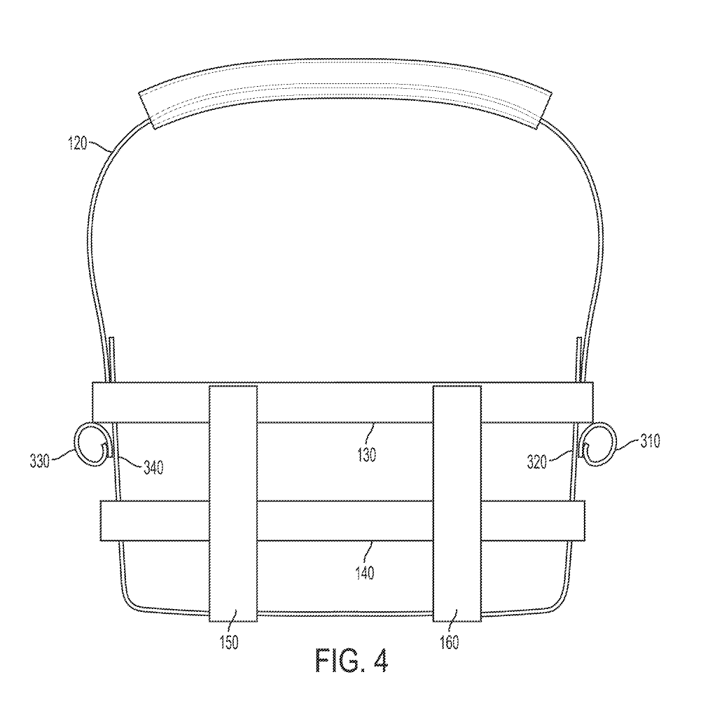

As seen in FIG. 4, multiple pull members may be used. For example, pull member 310 may be secured to vertical band 120 at junction 320, and pull member 330 may also be secured to vertical band 120 at junction 340. Multiple pull members can even further enhance versatility by enabling the battery to be pulled out and/or guided by either or both of pull member 310 and pull member 330. Again, multiple pull members may be configured on different portions of battery basket 110 as suitable. In addition, one or both of pull member 310 and/or pull member 330, or other pull members, may be slideably moveable along vertical band 120, first horizontal band 130 or second horizontal band 140, or first support band 150 or second support band 160, or added band.

It will be appreciated that the lower and/or bottom portion of battery basket 110 can be constructed in multiple configurations, fashions and designs. These include added or fewer strips. This can also include a generally integral pouch that can be carried by a handle such as by a portion of vertical member 120 with or without a gripping member 170.

In addition, it will be appreciated that in embodiments horizontal band 130 and horizontal band 140 can be substantially parallel with respect to each other. It will also be appreciated that additional configurations can be used in further embodiments. For example, horizontal band 130 and/or horizontal band 140 can cross each other at opposite junction points, forming an “X” shape at each of two such junctions. Added horizontal bands can be used.

Further, in embodiments first support band 150 and second support band 160 can be substantially parallel with respect to each other. It will also be appreciated that additional configurations can be used in further embodiments. For example, first support band 150 and second support band 160 can cross each other at a junction point, forming an “X” shape at such junctions. Added support bands can be used.

Further, it will be appreciated that in embodiments first vertical band can be substantially perpendicular to first horizontal band 130 and second horizontal band 140. The angle can, however, be varied in other embodiments.

The disclosures herein relate to a motorcycle battery. However, the disclosures herein can also be applied to a battery of another vehicle or device requiring a battery, such as but not limited to an automobile, boat, jet ski, snowmobile, lawnmower, recreational vehicle, all-terrain vehicle, or construction equipment.

In the description hereof, reference is made to the accompanying drawings which illustrate several embodiments of the present invention. It is understood that other embodiments may be utilized, and mechanical, compositional, structural, and other operational changes may be made without departing from the spirit and scope of the present disclosure. The following detailed description is not to be taken in a limiting sense, and the scope of the embodiments of the present invention is defined only by the claims of the issued patent.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, those skilled in the art will appreciate that the structures for securing described herein (e.g., forming the junctions) may be replaced or supplemented by other suitable securing means including a variety of other types of mechanical securing devices (e.g., nails, rivets, or others). In another example, a particular choice of construction material (e.g., polymeric, etc.) may be replaced or supplemented by another type of material which is suitable for the same or similar structure or function.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

It will be appreciated that, for convenience and clarity of disclosure, terms describing relative orientation or spatial positioning such as “vertical,” “horizontal,” “up,” “down,” “top,” “front,” “back,” or “bottom,” may be used at times herein with respect to the drawings and text description in association with various embodiments of the invention. However, such terms are primarily used for illustrative purposes and are not necessarily intended to be limiting in nature.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art. For example, there may be variations to these diagrams or the operations described herein without departing from the spirit of the invention.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

While the invention has been described in terms of particular embodiments and illustrative figures, those of ordinary skill in the art will recognize that the invention is not limited to the embodiments or figures described.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. An assembly for engaging a battery, comprising:
a first vertical band disposed in a loop configuration;
at least one horizontal band disposed in a loop configuration, the at least one horizontal band secured, by at least one junction, to the first vertical band; and
at least one support band, the at least one support band secured, by at least one junction, to the at least one horizontal band.

2. The assembly of claim 1, further comprising a grip member engaging the first vertical band.

3. The assembly of claim 1, further comprising a pull member, the pull member engaging the first vertical band, the at least one horizontal band, or the at least one support band.

4. The assembly of claim 3, wherein the pull member is substantially in the shape of a loop.

5. The assembly of claim 1, further comprising two or more pull members, the two or more pull members engaging the first vertical band, the at least one horizontal band, or the at least one support band.

6. The assembly of claim 3, wherein the pull member is secured to a fixed position on the first vertical band, the at least one horizontal band, or the at least one support band.

7. The assembly of claim 3, wherein the pull member is slideably moveable with respect to the first vertical band, the at least one horizontal band, or the at least one support band.

8. The assembly of claim 1, wherein the first vertical band and the at least one horizontal band are substantially perpendicular at two junction points.

9. An assembly for engaging a battery, the assembly comprising:
vertical means for engaging the battery along a substantially vertical axis; and
horizontal means for engaging the battery along a substantially horizontal axis, wherein the vertical means and horizontal means are secured to each other by at least one junction.

10. The assembly of claim 9, further comprising a grip member engaging the vertical means.

11. The assembly of claim 9, further comprising a pull member secured to the vertical means or horizontal means.

12. The assembly of claim 11, wherein the pull member is substantially in the shape of a loop.

13. The assembly of claim 9, further comprising two or more pull members secured to the vertical means or horizontal means.

14. The assembly of claim 9, further comprising a support means for supportably engaging the battery.

15. The assembly of claim 9, wherein the vertical means and horizontal means comprise a substantially flexible material.
